(19) United States
(12) Patent Application Publication
(10) Pub. No.: US 2024/0012016 A1
(43) Pub. Date: Jan. 11, 2024

(54) ANALYSIS SYSTEM AND ANALYSIS METHOD

(71) Applicant: SHIMADZU CORPORATION, Kyoto-shi (JP)

(72) Inventor: Motomu HINOOKA, Kyoto-shi (JP)

(73) Assignee: SHIMADZU CORPORATION, Kyoto-shi (JP)

(21) Appl. No.: 18/213,479

(22) Filed: Jun. 23, 2023

(30) Foreign Application Priority Data
Jul. 7, 2022 (JP) 2022-109775

(51) Int. Cl. G01N 35/04; G01N 35/00

(52) U.S. Cl. CPC G01N 35/04; G01N 35/00722; G01N 2035/0432; G01N 2035/009; G01N 2035/0475

(57) ABSTRACT

An analysis system includes a gripper arm for conveying a sample container, and a controller for controlling the gripper arm. The gripper arm includes a first gripper and a second gripper for holding the sample container by pinching the sample container, a drive mechanism that changes a size of a gripping space between the first gripper and the second gripper, and a photoelectric sensor for emitting light to the gripping space to detect the light from the gripping space. The controller determines the presence or absence of the sample container in the gripping space based on the presence or absence of a detection signal of the photoelectric sensor.

### CROSS-REFERENCE TO RELATED APPLICATIONS

This application claims priority under 35 U.S.C. § 119 to Japanese Patent Application No. 2022-109775 filed on Jul. 7, 2022, the entire disclosure of which is incorporated herein by reference in its entirety.

### BACKGROUND OF THE INVENTION

### Field of the Invention

The following description sets forth the inventor's knowledge of related art and problems therein and should not be construed as an admission of knowledge in the prior art.

Conventionally, an analysis system including a pretreatment apparatus is known. The pretreatment apparatus performs a pretreatment on cells contained in a sample, such as, e.g., a culture medium. The pretreatment includes various treatments, such as, e.g., centrifugation, fluid removal, reagent supply, stirring, and extraction. An analysis system is provided with a gripper arm for moving a sample container containing a sample. The gripper arm moves the sample container gripped by being sandwiched between a pair of grippers to a position corresponding to the application. The pretreated sample is supplied to an analysis device, such as, e.g., a liquid chromatograph mass spectrometer included in the analysis system.

In Japanese Unexamined Patent Application Publication No. 2019-174369, it discloses a pretreatment apparatus provided with a robot arm corresponding to a gripper arm. The robot arm conveys the sample container gripped by the hands to a pretreatment unit.

The conventional gripper arm equipped by the analysis system does not have a function of detecting whether a sample container is present between a pair of grippers. Therefore, in the conventional analysis system, the gripper arm is operated without determining the presence or absence of a sample container between the pair of grippers. Therefore, it is conceivable to determine whether a sample container is present between a pair of grippers by detecting a change in the motor current or the like of the gripper arm to measure the gripping force of the grippers.

However, the sample container to be gripped by the gripper arm may be damaged if it is strongly pressed, and therefore the gripper arm is required to grip a sample container with a force smaller than a force required to handle an industrial part. For this reason, in the method of detecting a change in the motor current of the gripper arm or the like, there is a possibility that the variation in the motor current is too small to accurately determine whether a sample container is present between the pair of grippers.

### SUMMARY OF THE INVENTION

It is an object of the present disclosure to make it possible to detect whether a sample container is present between grippers of a gripper arm by an optimal detection means considering the characteristics of the analyzing system.

An analysis system according to this disclosure is an analysis system including a pretreatment apparatus for pretreating a sample.

The analysis system includes:
a gripper arm configured to convey a sample container; and
a controller configured to control the gripper arm,
wherein the gripper arm includes
a first gripper and a second gripper for gripping the sample container by pinching the sample container,
a drive mechanism configured to change a size of a gripping space between the first gripper and the second gripper, and
a photoelectric sensor configured to emit light to the gripping space and detect the light from the gripping space, and
wherein the controller determines the presence or absence of the sample container in the gripping space based on the presence or absence of a detection signal of the photoelectric sensor.

In a method of controlling a gripper arm for conveying a sample container according to the present disclosure, the gripper arm includes a first gripper and a second gripper for gripping the sample container by pinching the sample container.

The method comprises the steps of:
changing a size of a gripping space between the first gripper and the second gripper;
emitting light to the gripping space to detect the light from the gripping space; and
determining the presence or absence of the sample container in the gripping space, based on whether the light from the gripping space is detected.

The above-described and other objects, features, aspects, and advantages of the present invention will become apparent from the following detailed description of the invention, taken in conjunction with the accompanying drawings.

### BRIEF DESCRIPTION OF THE DRAWINGS

The preferred embodiments of the present invention are shown by way of example, and not limitation in the accompanying figures.

FIG. 1 is a front view showing a schematic configuration of an analysis system.

FIG. 2 is a perspective view showing a schematic configuration of a pretreatment apparatus.

FIG. 3 is a perspective view showing a configuration of a gripper arm in the vicinity of the gripper.

FIG. 4 is a block diagram showing a configuration of an analysis system.

FIG. 5 is a diagram for describing an open state and a gripping state of a gripper arm.

FIG. 6 is a diagram for describing a state in a state in which a gripper arm at a position of a module is not detecting a sample container and a state in which the gripper arm is detecting a sample container.

FIG. 7 is a flowchart showing a processing procedure for determining the presence or absence of a sample container in a gripping space.

FIG. 8 is a flowchart showing a processing procedure of a pretreatment apparatus when a pretreatment apparatus is restored from power interruption.

FIG. 9 is a flowchart showing a processing procedure of a pretreatment apparatus when an operation of a start button is detected.

FIG. 10 is a flowchart showing a processing procedure of a pretreatment apparatus during a conveyance process of a sample container.

### DETAILED DESCRIPTION OF THE PREFERRED EMBODIMENTS

Hereinafter, some embodiments of the present disclosure will be described below with reference to the attached drawings. Note that in the drawings, the same or corresponding part is assigned by the same reference symbol, and the description thereof will not be repeated.

### <Schematic Configuration of Analysis System 100>

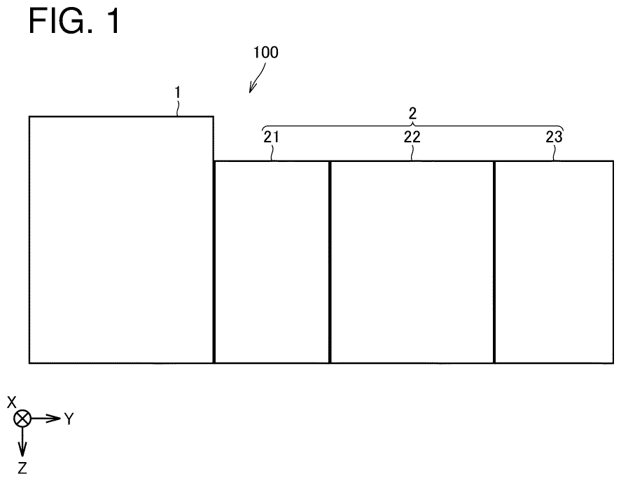

FIG. 1 shows a front view showing a schematic configuration of an analysis system 100. In this embodiment, three axes of X, Y, and Z perpendicular to each other are defined as shown in the figures. The X-Y plane formed by the X-axis and the Y-axis is a plane parallel to the installation plane of the analysis system 100.

The analysis system 100 is a system for automatically performing a pretreatment and an analysis of an analysis target. In this embodiment, the analysis target is a cell contained in a liquid sample, such as, e.g., a culture medium, and more specifically is a bacterial cell.

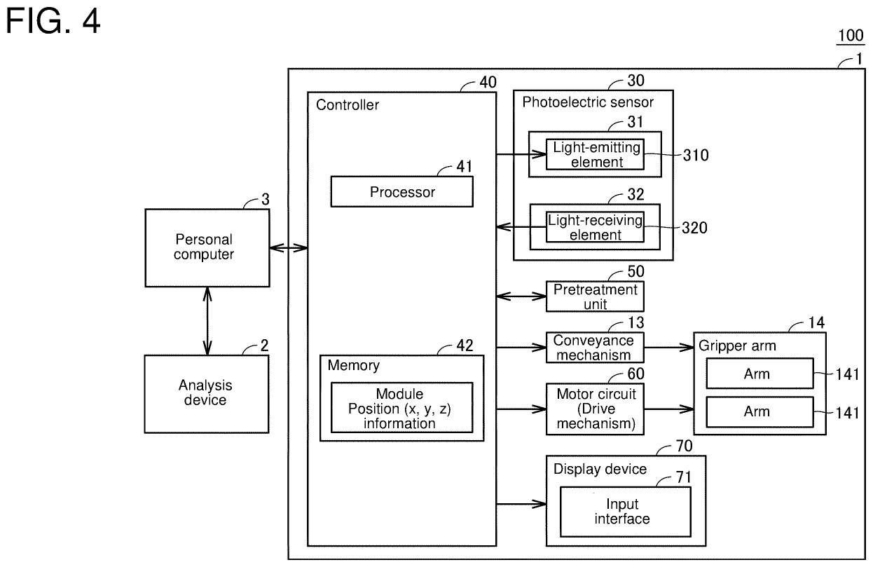

The analysis system 100 includes a pretreatment apparatus 1 and an analysis device 2. The analysis system 100 further includes a personal computer 3 communicatively connected to the pretreatment apparatus 1 and the analysis device 2 (see FIG. 4).

The pretreatment apparatus 1 has various pretreatment mechanisms, such as, e.g., a centrifugal mechanism, a liquid removal mechanism, a reagent supply mechanism, a stirring mechanism, and an extraction mechanism. The pretreatment apparatus 1 operates these mechanisms to sequentially perform pretreatments on a liquid sample. The pretreatment apparatus 1 may be provided with a function of automatically conveying a pretreated liquid sample into an auto sampler 21.

The analysis device 2 includes an auto sampler 21, a liquid chromatographic apparatus 22, and a mass spectrometer 23. The auto sampler 21, the liquid chromatographic apparatus 22, and the mass spectrometer 23 are connected by piping and wiring (not shown).

The auto sampler 21 is a device for sampling a liquid sample from a sample container (labware). A liquid sample (hereinafter also simply referred to as “sample”) pretreated by the pretreatment apparatus 1 is introduced into the liquid chromatographic apparatus 22 via the auto sampler 21. Thereafter, the sample is analyzed by the liquid chromatographic apparatus 22 and the mass spectrometer 23.

In FIG. 1, the concept of the analysis device 2 includes the auto sampler 21, but the auto sampler 21 may be excluded from the analysis device 2. The liquid chromatographic apparatus 22 and the mass spectrometer 23 are merely an example of an analysis device for analyzing an analysis target. Another analysis device may be adopted for the analysis system 100.

### <Schematic Configuration of Pretreatment Apparatus 1>

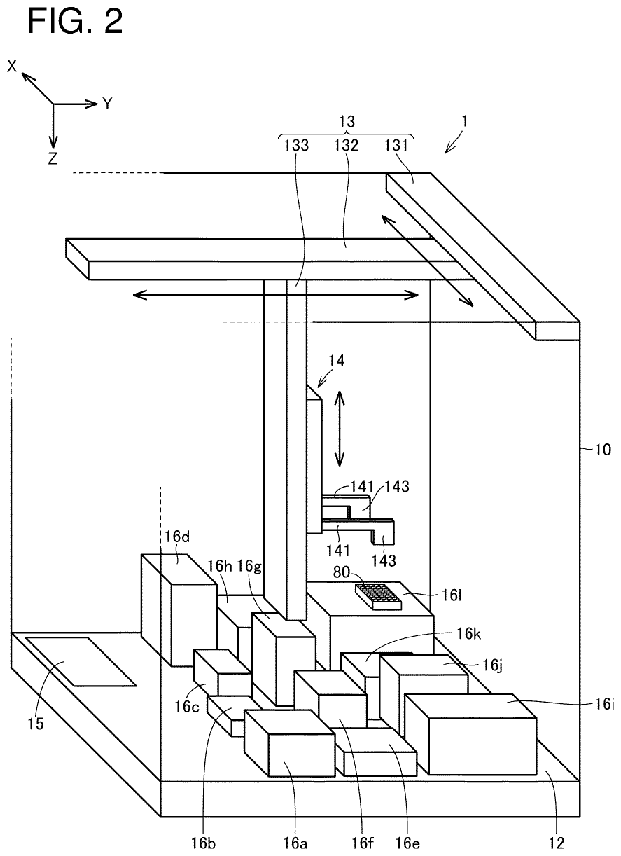

FIG. 2 is a perspective view showing the schematic configuration of the pretreatment apparatus 1. As shown in FIG. 2, the pretreatment apparatus 1 has a table 12 having a top surface parallel to the X-Y plane. The entire space above the table 12 is enclosed by a housing 10. On the table 12, a plurality of modules 16a to 161 is mounted in a matrix of approximately four rows and three columns.

These modules 16a to 161 each have a distinct pretreatment function. Each of the modules 16a to 161 varies in size. However, the present disclosure does not exclude aspects in which all of modules 16a to 161 are the same. On the modules 16a to 161, a sample container 80 containing a sample as a pretreatment target is placed. The modules 16a to 161 each perform a pretreatment corresponding to each function on a sample in the sample container 80. The modules 16a to 161 are examples of a plurality of placement portions on which the sample container 80 is placed. The module 16a is one example of a first placement portion, and the module 16b is one example of a second placement portion. Hereinafter, the modules 16a to 161 may be collectively referred to as a module 16.

A conveyance mechanism 13 is provided above the table 12. The conveyance mechanism 13 is provided with an X-axis guide rail 131 extending in the X-axis direction, a Y-axis guide rail 132 extending in the Y-axis direction, and a Z-axis guide rail 133 extending in the Z-axis direction. The X-axis guide rail 131 is attached to the top portion of the housing 10. The Y-axis guide rail 132 is attached to the X-axis guide rail 131 to be movable along the X-axis guide rail 131 in the X-axis direction. The Z-axis guide rail 133 is attached to the Y-axis guide rail 132 to be movable along the Y-axis guide rail 132 in the Y-axis direction. A gripper arm 14 is attached to the Z-axis guide rail 133 to be movable in the Z-axis direction. The conveyance mechanism 13 is further provided with a plurality of drive mechanisms (not shown). The plurality of drive mechanisms moves the Y-axis guide rail 132 in the X-axis direction, the Z-axis guide rail 133 in the Y-axis direction, and the gripper arm 14 in the Z-axis direction. With this, the gripper arm 14 moves in three axial directions of the X-axis, the Y-axis, and the Z-axis in the housing 10.

The gripper arm 14 has a pair of arms 141. A gripper 143 for gripping the sample container 80 by pinching it is provided at the tip end of the arm 141. The gripper arm 14 grips the sample container 80 containing a sample with the gripper 143 and conveys the sample container 80 to a module 16 out of the plurality of modules 16a to 161 for performing a preset pretreatment.

A retraction area 15 is provided above the table 12. The gripper arm 14 causes the sample container 80 to retract to the retraction area 15 as necessary.

### <Configuration of Gripper Arm 14>

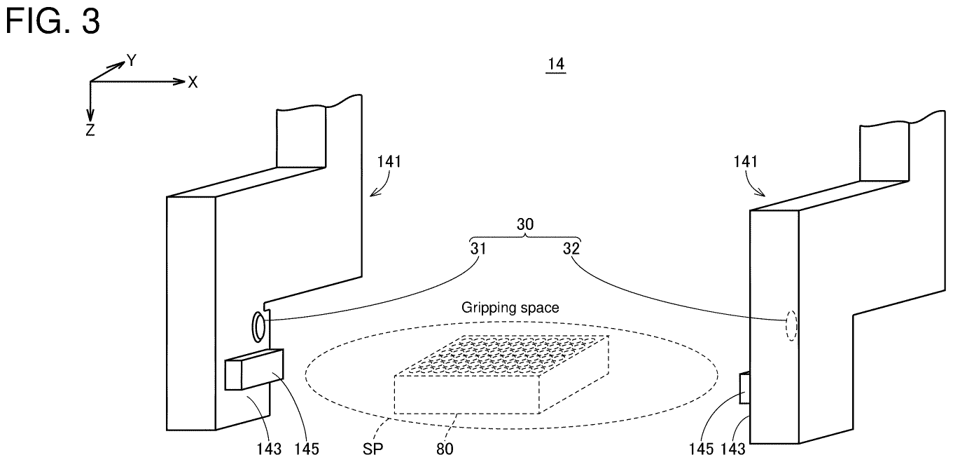

FIG. 3 is a perspective view showing the configuration of the gripper arm 14 in the vicinity of the gripper 143. As shown in FIG. 3, a gripper 143 is formed at the tip end of each of the pair of arms 141. Both the grippers 143 are each provided with a substantially rectangular parallelepiped elastic member 145. Between the pair of grippers 143, there is a gripping space SP for the gripper arms 14 to grip the sample container 80. The gripper arms 14 change the size of the gripping space SP by changing the space between the pair of arms 141 to hold the sample container 80 between the pair of grippers 143. At this time, among the plurality of surfaces of the pair of elastic members 145 having a substantially rectangular parallelepiped shape, the surface facing the gripping space SP abuts against the sample container 80.

Of the pair of grippers 143, one of the grippers 143 is provided with a light-projecting unit 31, and the other gripper 143 is provided with a light-receiving unit 32. In the pair of grippers 143, the light-projecting unit 31 and the light-receiving unit 32 are provided at opposite positions so that the light output from the light-projecting unit 31 is incident on the light-receiving unit 32. The light-projecting unit 31 and the light-receiving unit 32 constitutes a photoelectric sensor 30. In this embodiment, the photoelectric sensor 30 is used to detect whether a sample container 80 is present in the gripping space SP. One of the pair of arms 141 is an example of a first arm, and the other thereof is an example of a second arm.

### <Block Diagram of Pretreatment Apparatus 1>

FIG. 4 is a block diagram showing the configuration of the analysis system 100. As shown in FIG. 4, the pretreatment apparatus 1 is provided with the controller 40, the photoelectric sensor 30, the pretreatment unit 50, the conveyance mechanism 13, the gripper arm 14, a motor circuit 60, and a display device 70.

The controller 40 includes a processor 41 and a memory 42. The controller 40 is communicatively connected to the analysis device 2 via, for example, a personal computer 3.

The processor 41 is typically a CPU (Central Processing Unit) or an MPU (Multi-Processing Unit), etc. The processor 41 realizes various processing of the pretreatment apparatus 1 by reading and executing programs stored in the memory 42. The memory 42 includes a RAM (Random Access Memory), a ROM (Read Only Memory), a flash memory, a hard disk, and the like. In addition to the programs to be executed by the processor 41, the memory 42 stores various data, such as, e.g., settings for the pretreatment and position information (x-coordinate, y-coordinate, and z-coordinate) on the modules 16a to 16l.

The photoelectric sensor 30 is provided with a light-projecting unit 31 including a light-emitting element 310 and a light-receiving unit 32 including a light-receiving element 320. The photoelectric sensor 30 emits light to the gripping space SP between the pair of grippers 143 and detects the light passing through the gripping space SP. The photoelectric sensor 30 is one example of a photoelectric sensor that emits light to the gripping space SP between the pair of grippers 143 and detects the light from the gripping space SP.

The controller 40 drives the light-projecting unit 31 with, for example, a pulse width modulated signal of a predetermined pulse width. With this, the light-projecting unit 31 outputs light in synchronization with the pulse-width modulated signal. The light-receiving unit 32 detects the light output from the light-projecting unit 31. Upon detecting the light, the light-receiving unit 32 transmits a detection signal to the controller 40.

The pretreatment unit 50 executes a pretreatment corresponding to each of the modules 16a to 161 based on a preset schedule.

The conveyance mechanism 13 includes an X-axis guide rail 131, a Y-axis guide rail 132, and a Z-axis guide rail 133. The conveyance mechanism 13 further includes a plurality of drive mechanisms (not shown). The controller 40 controls the plurality of drive mechanisms to move the Y-axis guide rail 132 in the X-axis direction, the Z-axis guide rail 133 in the Y-axis direction, and the gripper arm 14 in the Z-axis direction. With this, the gripper arm 14 moves in the housing 10 in the three-axis directions of X, Y, and Z.

The motor circuit 60 is one example of the drive mechanism for driving the pair of arms 141 of the gripper arm 14. The controller 40 controls the motor circuit 60 to change the separation distance of the pair of arms 141. This changes the size of the gripping space SP between the gripper 143 provided at the tip end of one arm 141 and the gripper 143 provided at the tip end of the other arm 141.

The display device 70 includes, for example, a touch panel having a liquid crystal display. The display device 70 includes an input interface 71 constituted by a touch panel. The input interface 71 receives a touch-operation of the user. The input interface 71 functions as, for example, an analysis condition input unit that accepts analysis conditions from the user. Further, an input interface 71 receives an instruction to start execution of a pretreatment and various instructions during the pretreatment. Further, the display device 70 displays various alarm information based on the information output from the controller 40. The display device is one example of a notification device.

### <Open State and Gripping State>

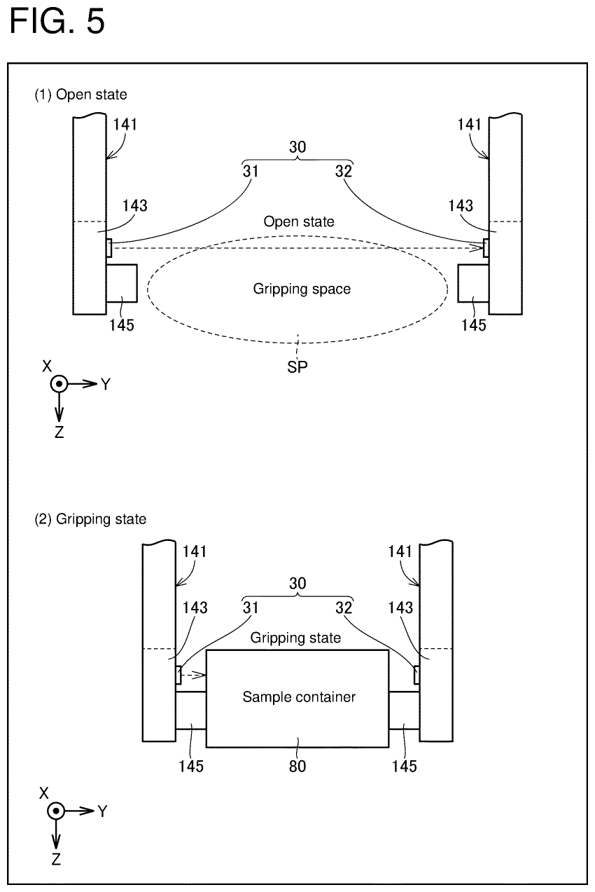

FIG. 5 is a diagram for describing an open state and a gripping state of the gripper arm 14. (1) in FIG. 5 shows the open state of the gripper arm 14, and (2) in FIG. 5 shows the gripping state of the gripper arm 14.

By changing the separation distance of the pair of arms 141, the gripper arm 14 changes between the open state in which no sample container 80 is gripped in the gripping space SP and the gripping state in which the sample container 80 is gripped in the gripping space SP.

As shown in (1) in FIG. 5, in the open state, when no sample container 80 is present in the gripping space SP, the light output from the light-projecting unit 31 passes through the gripping space SP and is received by the light-receiving unit 32.

As shown in (2) in FIG. 5, in the gripping state, since the sample container 80 is present in the gripping space SP, the optical path of the light output from light-projecting unit 31 toward light-receiving unit 32 is blocked by the sample container 80. Therefore, in the light-receiving unit 32, the light output from the light-projecting unit 31 is not received.

When the gripper arm 14 is being moved in the space in the pretreatment apparatus 1 with the sample container 80 gripped, the sample container 80 may fall from the pair of grippers 143 due to unexpected vibrations or other effects. In this case, the light output from the light-projecting unit 31 reaches the light-receiving unit 32 without being blocked by the sample container 80. Consequently, the light-receiving unit 32 starts detecting the light output by the light-projecting unit 31.

The controller 40 determines the presence or absence of the detection output of the light-receiving unit 32 to thereby determine, for example, that the gripper arm 14 is in the gripping state in which the gripper arm 14 is gripping the sample container 80, and that the sample container 80 which is being conveyed by the gripper arm 14 is no longer present (dropped) during the conveyance or the like.

In this way, the pretreatment apparatus 1 can determine the presence or absence of the sample container 80 by using the detection output of the photoelectric sensor 30. Particularly, in this embodiment, one of the features is that the photoelectric sensor 30 is adopted as a sensor used for determining the presence or absence of the sample container 80.

Regarding a common robot arm that handles industrial parts or the like, it is conceivable to specify the gripping force when the robot arm grips the industrial part based on the motor current or the like and determine whether the robot arm is gripping the industrial product based on the magnitude of the motor current.

However, the object to be gripped by the gripper arm 14 is the sample container which cannot be said to have a high strength against the pressure. For this reason, the gripper arm 14 is required to be able to grip the sample container with an appropriate force that does not strongly press the sample container, as compared with a conventional robot arm that handles industrial parts and the like. Therefore, in a method of detecting the magnitude of the motor current or the like of the gripper arm 14, there is a possibility that the amount of change in the motor current is too small to accurately determine whether the sample container is present between the pair of grippers 143.

Therefore, in this embodiment, the photoelectric sensor 30 is adopted to determine the presence or absence of the sample container 80. According to the photoelectric sensor 30, regardless of the magnitude of the gripping force for the gripper arm 14 to grip the sample container 80, it is possible to detect whether the sample container 80 is present in the gripping space SP without directly contacting the sample container 80 itself for sensing. According to this embodiment, whether the sample container 80 is present between the grippers 143 of the gripper arm 14 can be detected by the photoelectric sensor 30, which is the optimum detection means considering the characteristics of the analysis system 100.

As shown in FIG. 5, the light-projecting unit 31 and the light-receiving unit 32, constituting the photoelectric sensor 30 are attached to positions different from the contact surfaces of the elastic members 145 with which the sample container 80 comes into contact. More specifically, the light-projecting unit 31 and the light-receiving unit 32 are provided on the gripping space SP side of the gripper 143 and above the elastic members 145 in the Z-axis direction. The thickness of the light-projecting unit 31 and that of the light-receiving unit 32 in the Y-axis direction are thinner than the thickness of the elastic member 145 in the Y-axis direction.

Thus, when the sample container 80 is gripped by the pair of grippers 143, the light-projecting unit 31 and the light-receiving unit 32 do not come into contact with the sample container 80. Therefore, it is possible to prevent the light-projecting unit 31 and the light-receiving unit 32 from being pressed by the sample container 80 and the elastic member 145, thereby preventing the occurrence of functional problems of the light-projecting unit 31 and the light-receiving unit 32. Further, even in a case where a part of a liquid sample is adhered to the side surface of the sample container 80, it is possible to prevent the liquid sample from wetting the light-projecting unit 31 and the light-receiving unit 32. Consequently, it is possible to prevent the functions of the light-projecting unit 31 and the light-receiving unit 32 from being impaired by the liquid sample.

Note that in the Z-axis direction, the light-projecting unit 31 and the light-receiving unit 32 may be provided below the elastic member 145 instead of above the elastic member 145.

### <Method for Detecting Presence or Absence of Sample Container 80 on Module 16>

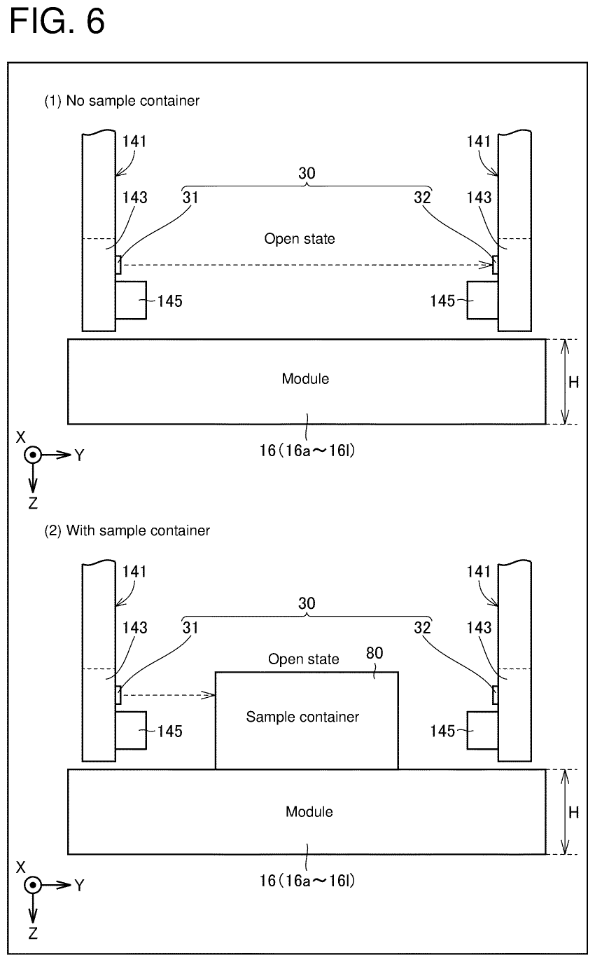

FIG. 6 is a diagram for describing the state in which the gripper arm 14 located at the position of the module 16 is not detecting the sample container 80 and the state in which the gripper arm 14 is detecting the sample container 80. (1) in FIG. 6 shows the state in which the gripper arm 14 located at the position of the module 16 is not detecting the module 16. (2) of FIG. 6 shows the state in which the gripper arm 14 located at the position of the module 16 is detecting the sample container 80.

The controller 40 starts the pretreatment according to the set schedule and moves the sample container 80 to the module 16. Normally, no sample container 80 has been placed on the module 16 which is a scheduled destination. However, there is a possibility that the user has mistakenly placed another sample container 80 which is not supposed to be subjected to a pretreatment on the module 16. If a pretreatment is initiated in a case where a sample container 80 to be subjected to a pretreatment and another sample container are placed on the modules 16, the two sample containers 80 collide, thus preventing correct execution of the pretreatment.

Therefore, before initiating the pretreatment, the controller 40 confirms that no sample container 80 is present on the module 16.

As shown in (1) in FIG. 6, in a case where no sample container 80 is present in the gripping space SP in the open state, the light output from the light-projecting unit 31 passes through the gripping space SP and is received by the light-receiving unit 32. As shown in (1) in FIG. 6, by placing the gripper arm 14 in the open state above the module, the controller confirms that no sample container 80 is present on the module 16. The height H of the module 16 shown in FIG. 6 varies depending on the modules 16a to 16l. The controller 40 identifies the position information on the modules 16a to 161 including the height H (z-coordinate), based on the module position information (x-coordinate, y-coordinate, z-coordinate) stored in the memory 42. The controller 40 uses the identified position information to position the grippers 143 of the gripper arm 14 at the optimal positions of the placement surface on the module 16.

As shown in (2) in FIG. 6, in a case where the sample container 80 is present in the gripping space SP in the open state, the optical path of the light output from the light-projecting unit 31 toward the light-receiving unit 32 is blocked by the sample container 80. Therefore, in the light-receiving unit 32, the light output from the light-projecting unit 31 is not received. The controller 40 confirms that the sample container 80 is present on the module 16 based on that the light is not received by the light-receiving unit 32 when the gripper arm 14 in the open state is placed above the module 16.

### <Processing at the Time of Power Restoration>

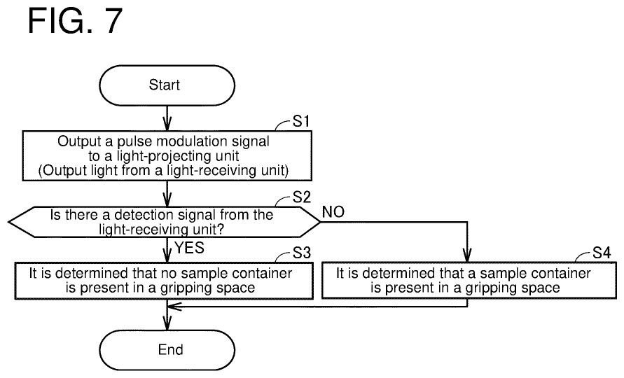

FIG. 7 is a flowchart showing a processing procedure for determining the presence or absence of the sample container 80 in the gripping space SP. Initially, the controller 40 outputs a pulse-modulated signal to the light-projecting unit 31 (Step S1). By the processing in Step S1, the light-projecting unit 31 outputs light toward the gripping space SP at the timing corresponding to the pulse-modulated signal. When no sample container 80 is present in the gripping space SP, the light emitted to the gripping space SP is incident on the light-receiving unit 32.

Next, the controller 40 determines whether a light detection signal has been received from the light-receiving unit 32 (Step S2). In a case where the light detection signal is received from the light-receiving unit 32, the controller 40 determines that no sample container 80 is present in the gripping space SP (Step S3). In a case where the light detection signal is not received from the light-receiving unit 32, the controller 40 determines that the sample container 80 is present in the gripping space SP (Step S4). Thereafter, the controller 40 terminates the processing based on this flowchart.

### <Processing at the Time of Power Restoration>

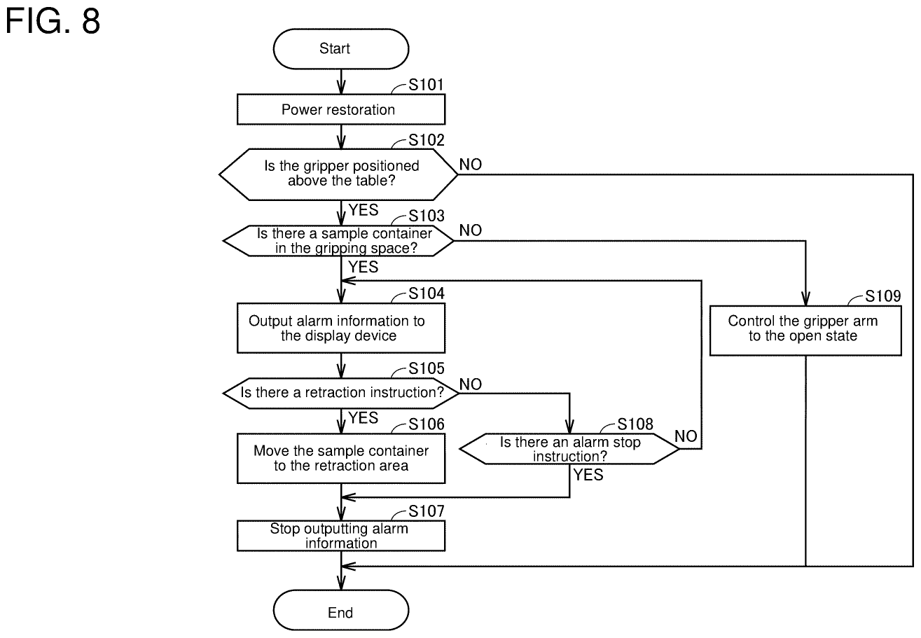

FIG. 8 is a flowchart showing the processing procedure of the pretreatment apparatus 1 when the pretreatment apparatus 1 is restored from the power interruption. The processing based on this flowchart is executed by the controller 40 equipped by the pretreatment apparatus 1.

During the conveyance of the sample container 80 by the gripper arm 14, the power interruption may occur due to a power failure or the like. In this case, the gripper 143 stops with the sample container 80 held in the upper space of the table 12. If the gripper arm 14 is controlled to the open state in the same manner as in the normal initial operation when the power is restored from the power interruption, the sample container 80 held in the upper space of the table 12 will drop onto the table 12. The liquid sample flowed out of the dropped sample container 80 may adversely affect the surrounding modules 16. Further, there is a possibility that the other sample container 80 is contaminated with the liquid sample flowing out of the dropped sample container 80.

When the controller 40 executes the processing according to the processing procedure shown in FIG. 8, it is possible to prevent the sample container 80, which was retained in the space in the housing 10 at the time of the power interruption return, from falling onto the table 12. Hereinafter, the processing procedure will be described based on FIG. 8.

First, the controller 40 identifies that the power interruption of the pretreatment apparatus 1 has been restored (Step S101). When the controller 40 identified that the power interruption of the pretreatment apparatus 1 has been restored, it determines whether the gripper 143 is positioned above the table 12 (Step S102).

The controller 40 identifies the coordinate position of the gripper 143 in the space of the housing 10, based on, for example, the drive step numbers for each of the X-axis, the Y-axis, and the Z-axis of the drive mechanism (including a motor) included in the conveyance mechanism 13. The controller 40 identifies the position of the gripper 143 in the housing 10, based on the coordinate location of the gripper 143. The controller 40 determines that “the gripper 143 is positioned above the table 12” when the distance between the module 16 positioned below the gripper 143 and the gripper 143 is equal to or greater than a specified value. By making such a determination, the controller 40 can determine whether there is a possibility that the gripper 143 was moving in the housing 10 while holding the sample container 80 before the occurrence of the power interruption.

In a case where it is determined that the gripper 143 is not positioned above the table 12, the controller 40 terminates the processing based on this flowchart. In a case where it is terminated that the gripper 143 is positioned above the table 12, the controller 40 determines whether the sample container 80 is present in the gripping space SP of the gripper 143 (Step S103). The controller 40 determines the presence or absence of the detection output of the light-receiving unit 32 to determine whether the sample container 80 is present in the gripping space SP (see FIG. 7).

In a case where the controller 40 determines that no sample container 80 is present in the gripping space SP of the gripper 143, the controller 40 controls such that the gripper arm 14 becomes an open state (Step S109). This widens the separation distance of the pair of grippers 143, so that the arm 14 becomes the state shown in (1) in FIG. 5.

In a case where the sample container 80 is present in the gripping space SP of the gripper 143, the gripper arm 14 is in a state of gripping the sample container 80 (see (2) in FIG. 5). If it is controlled such that the gripper arm 14 becomes an open state from this condition, the sample container 80 falls onto the table 12. Therefore, in a case where it is determined that the sample container 80 is present in the gripping space SP of the gripper 143, the controller 40 outputs alarm information to the display device 70 without making the gripper arm 14 into an open state.

The display device 70 displays alarm information on the screen. It also displays a button for accepting an alarm stop instruction for stopping the alarm information and a button for accepting a retract instruction for making the sample container 80 retract to the retraction area 15 on the screen. These buttons cooperate with an input interface 71 constituted by a touch panel. The user performs an instruction input operation by touching the button. The display device 70 outputs the instruction information corresponding to the button touched by the user to the controller 40.

The controller 40 determines whether a retraction instruction is input (Step S105). When the retraction instruction is not input, the controller 40 determines whether an alarm stopping instruction is input (Step S108). When the alarm stop instruction is not input, the controller 40 returns the processing to Step S104. When the retraction instruction is input, the controller 40 controls the gripper arm 14 to move the sample container 80 gripped by the gripper 143 to the retraction area 15 (Step S106). Thereafter, the controller 40 stops the output of the alarm information and terminates the processing based on this flowchart (Step S107).

When an alarm stop instruction is input, the controller 40 stops outputting the alarm information (Step S107) and terminates the processing based on this flowchart. When an alarm stopping instruction is input, the controller 40 does not move the sample container 80 gripped by the gripper 143 to the retraction area 15. Therefore, in this case, the user takes a required action. However, even in a case where an alarm stopping instruction is input, it may be configured to execute the processing in Step S106.

As described above, in the flowchart shown in FIG. 8, when the power of the pretreatment apparatus 1 is turned on, the controller 40 determines the presence or absence of the sample container 80 in the gripping space SP.

Here, a case in which the power interruption caused by a power failure is restored is exemplified as an example of the power interruption restoration. However, this flowchart can also be applied to the case in which the user turns on the pretreatment apparatus 1 to perform a pretreatment using the pretreatment apparatus 1. Therefore, the controller 40 executes the processing based on this flowchart from the turning on the power source by the user to the pressing the start button for the pretreatment.

### <Processing at the Time of Starting Pretreatment>

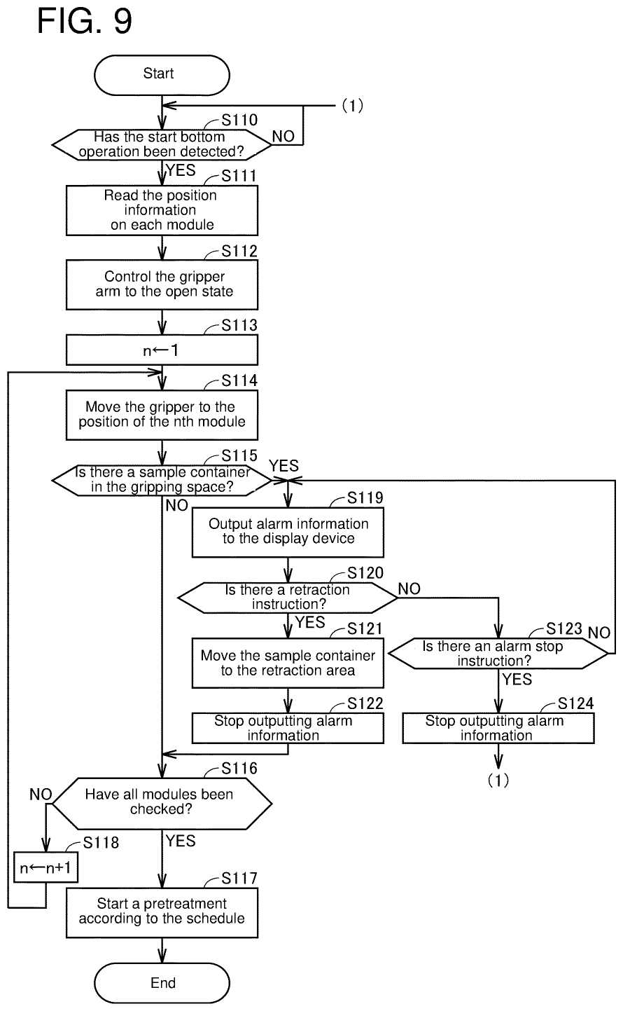

FIG. 9 is a flowchart showing the processing procedure of the pretreatment apparatus 1 when the operation of the start button is detected. The processing based on this flowchart is executed by the controller 40 equipped by the pretreatment apparatus 1.

When it is detected that the start button is operated, the controller 40 initiates the pretreatment according to the preset schedule to move the sample container 80 to the module 16. As described above, there is a possibility that the user has mistakenly placed the sample container 80 on the module 16 as a scheduled destination. If a pretreatment is initiated in this state, there occurs such a problem that the sample containers 80 collide with each other, and the pretreatment cannot be executed correctly. By executing the processing according to the processing procedure shown in FIG. 9 by the controller 40, it is possible to prevent the occurrence of such an issue. Hereinafter, the processing procedure will be described with reference to FIG. 9.

First, the controller 40 waits until the operation of the start button is detected (Step S110). The start button is displayed on the display device 70 including the touch panel. The detection signal is output from the display device 70 to the controller 40 when the user touches the start button. When the operation of the start button is detected, the controller 40 reads the position information on each module 16a to 161 from the memory 42 (Step S111).

Next, the controller 40 controls the gripper arm 14 to the open state (Step S112). This widens the gripping space SP of the gripper 143. Next, “n” for identifying the module 16 to be checked is set to 1 (Step S113). In this flowchart, the module 16a to the module 161 correspond to the 1st module to the 12th module, respectively. Next, the controller 40 moves the gripper 143 to the position of the “n” module (Step S114).

For example, if n=1, the controller 40 moves the gripper 143 to the position of the module 16a. Consequently, it becomes the state in which the positional relation between the gripper 143 and the module 16a is shown in FIG. 6. In Step S112, the gripper arm 14 is controlled in the open state. Therefore, even in a case where the sample container 80 is placed on the module 16a, the positional relation between the gripper 143 and the sample container 80 is the positional relation shown in (2) in FIG. 6. Consequently, the moving gripper 143 does not collide with the sample container 80.

Next, the controller 40 determines whether the sample container 80 is present in the gripping space SP of the gripper 143 (Step S115). Specifically, the controller 40 determines whether the sample container 80 is present in the gripping space SP by determining the presence or absence of the detection output of the light-receiving unit 32 (see FIG. 7). (1) in FIG. 6 shows an example in which the sample container 80 is not present in the gripping space SP. (2) in FIG. 6 shows an example in which the sample container 80 is present in the gripping space SP.

When the controller 40 determines that the sample container 80 is present in the gripping space SP of the gripper 143, it outputs alarm information to the display device 70 (Step S119) and waits for an alarm stop instruction or an alarm wait instruction (Step S120, Step S123). The controller 40 stops outputting the alarm information when an alarm stop instruction is issued (Step S124). When there is a retraction instruction, the controller 40 moves the sample container 80 placed on the module 16 to the retraction area 15 (Step S121) and stops outputting the alarm information (Step S122)

The processing of Step S119 to Step S123 is the same as Step S104 to Step S108 described with reference to FIG. 8. The processing of Step S124 is the same as the that of Step S122. Therefore, the detailed explanation of each Step will not be repeated here. When the controller 40 stops outputting the alarm information based on the alarm stop instruction (Step S124), it returns the processing to Step S110 that detects the start button operation. After that, the controller 40 enters a state of waiting for the detection of the start button operation. For example, the user removes the sample container 80 mistakenly placed on the module 16 and then operates the start button again.

After stopping the output of the alarm information in Step S122, the controller 40 determines whether all the modules 16a to 161 have been checked (Step S116). When all the modules 16a to 161 have not been checked, the controller 40 updates the “n” (Step S118) and moves the gripper 143 to the position of the next module 16 (Step S114). Thereafter, the controller 40 repeats the processing Step S115 and thereafter.

In a case where the controller 40 determines that all the modules 16a to 161 have been checked, that is, it is determined that no sample container 80 is placed on the modules 16a to 161, a pretreatment according to the preset schedule is initiated (Step S117). Thereafter, the controller 40 terminates the processing based on the flowchart.

In the flowchart described with reference to FIG. 9, the controller 40 outputs the alarm information every time it is determined that the sample container 80 is placed on the module 16. However, it may be configured such that the controller 40 store the check result (presence or absence of the sample container 80) every time the module 16a to 161 is checked, and after completion of checking all the modules 16, alarm information corresponding to the check result is output. For example, when the sample containers 80 are placed on the modules 16a and 16d, the controller 40 may display that the sample containers 80 are placed on the modules 16a and 16d on the display device 70.

### <Processing in Conveyance Step>

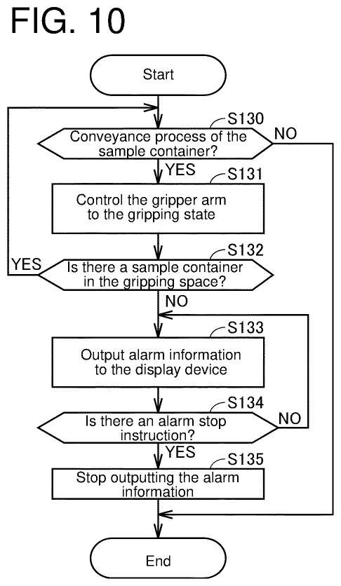

FIG. 10 is a flowchart showing the processing procedure of the pretreatment apparatus 1 in the conveyance step of the sample container. The processing based on this flowchart is executed by the controller 40 equipped by the pretreatment apparatus 1.

The controller 40 initiates the pretreatment according to the preset schedule in Step S117 in FIG. 9. The pretreatment includes the conveyance step in which the gripper arm 14 conveys the sample container 80 to the target module 16. In the conveyance step, the sample container 80 may fall from the gripper arm 14 due to the effect of unexpected oscillations or the like. In such a case, it is essential to detect the drop of the sample container 80 at an early stage, since an emergency response is required. By executing the processing according to the processing procedure shown in FIG. 10 by the controller 40, it is possible to notify that the sample container 80 has fallen from the gripper arm 14 during the conveyance step. Hereinafter, the processing procedure will be described with reference to FIG. 10.

Initially, the controller 40 determines whether the pretreatment step is a conveyance step of the sample container (Step S130). When it is determined that the pretreatment step is not the conveyance step of the sample container, the controller 40 terminates the processing based on this flowchart. When it is determined that the pretreatment step is the conveyance step of the sample container, the controller 40 controls the gripper arm 14 to the gripping state (Step S131). With this, the separation distance of the pair of grippers 143 is narrowed, and the sample container 80 is gripped by the grippers 143.

Next, the controller 40 determines whether the sample container 80 is present in the gripping space SP of the gripper 143 (Step S132). The controller 40 determines whether the sample container 80 is present in the gripping space SP by determining the presence or absence of the detection output of the light-receiving unit 32 (see FIG. 7). When the sample container 80 is present in the gripping space SP, the gripper arm 14 is moved toward the target module 16 while holding the sample container 80. In this case, the controller 40 returns the processing to Step S130.

When no sample container 80 is present in the gripping space SP of the gripper 143, it can be determined that the sample container 80 gripped by the gripper arm 14 is detached from the gripper arm 14 and fell. In this situation, the controller 40 outputs alarm information to the display device 70 (Step S133), waits for an alarm stop instruction to be input (Step S134), and stops the output of the alarm information (Step S135). Thereafter, the controller 40 terminates the processing based on the flowchart.

The processing in Step S133 to Step S135 is the same as the processing in Step S104, Step S108, and Step S107 described with reference to FIG. 8. Therefore, the detailed explanation of each Step will not be repeated here. The user can recognize that the sample container 80 has fallen during the conveyance step by looking at the alarm information displayed on the display device 70. This allows the user to take an immediate appropriate action against the fall of the sample container 80. In this way, in the flowchart shown in FIG. the controller 40 determines, in the conveyance step, the presence or absence of the sample container 80 in the gripping space SP.

### Modifications

Next, modifications related to this embodiment will be described.

The controller 40 may control the gripper arm 14 to convey the sample container containing a pretreated sample to the analysis device 2. That is, the gripper arm 14 may include not only a function of conveying the sample container 80 in the pretreatment apparatus 1 but also a function of conveying the sample container 80 from the pretreatment apparatus 1 to the analysis device 2. For example, the gripper arm 14 may convey the sample container 80 from the pretreatment apparatus 1 to the auto sampler 21 via the opening provided at the position at which the wall surface of the pretreatment apparatus 1 and the wall surface of the auto sampler 21 are opposed. The controller 40 may execute the processing based the processing procedure described with reference to FIG. 8 and FIG. 10 in the step of conveying the sample container 80 from the pretreatment apparatus 1 to the analysis device 2. This embodiment is applicable not only to the gripper arm 14 arranged in the pretreatment apparatus 1 but also to the gripper arm arranged in the analysis device 2. This sample container can be applied to a gripper arm that transports the sample container 80 to a target position, regardless of whether the sample in the sample container 80 is a pretreated sample or a pretreated analysis target sample. Also, the sample in the sample container 80 is not limited to a liquid sample. For example, a gel-like or solid sample may be stored in the sample container 80.

As long as it is possible to emit light to the gripping space SP between the pair of grippers 143 and detect the light passing through the gripping space SP, the photoelectric sensor 30 may be attached to a position different from the position where the photoelectric sensor 30 is attached. For example, the light-projecting unit 31 may be provided above the gripper 143 of one arm 141 and the light-receiving unit 32 may be provided below the elastic member 145 of the gripper 143 of the other arm 141. In this case, it is sufficient to adjust the illumination angle of the light from the light-projecting unit 31 so that the light output from the light-projecting unit 31 passes through the gripping space SP and is incident on the light-receiving unit 32 positioned below in the Z-axis direction.

In this embodiment, as one example of the photoelectric sensor for emitting light to the gripping space SP between the pair of grippers 143 and detecting the light from the gripping space SP, a transmissive photoelectric sensor 30 is exemplified. However, in place of the transmissive photoelectric sensor 30, a photoelectric sensor of either a retroreflective type or a diffuse reflective type may be used.

In a case where a retroreflective or diffusely reflective photoelectric sensor is used, the light-emitting element 310 and the light-receiving element 320 are provided on one of the pair of grippers 143. In this instance, the light-emitting element 310 and the light-receiving element 320 may be provided in a single unit. In the case of using a retroreflective photoelectric sensor, a retroreflective plate is provided on the other gripper 143. The light-emitting element 310 emits light to the retroreflective plate so that the light passes through the gripping space SP. The controller 40 determines that no sample container 80 is present in the gripping space SP when the reflected light from the retroreflector is detected by the light-receiving element 320. The controller 40 determines that the sample container 80 is present in the gripping space SP when no reflected light from the retroreflector is detected by the light-receiving element 320.

In the case of using a diffusely reflective photoelectric sensor, the light-emitting element 310 emits the light toward the gripping space SP. When the sample container 80 is present in the gripping space SP, the light emitted from the light-emitting element 310 is reflected by the sample container 80. The light-receiving element 320 detects the reflected light relative to the illumination light of the light-emitting element 310. The controller 40 determines that the sample container 80 is present in the gripping space SP when the reflected light is detected by the light-receiving element 320. The controller 40 determines that no sample container 80 is present in the gripping space SP when the reflected light is not detected by the light-receiving element 320.

As described above, the controller 40 can determine the presence or absence of the sample container 80 in the gripping space SP based on the presence or absence of the detection signal of the photoelectric sensor regardless of whether the photoelectric sensor is the transmissive type, the retroreflective type, or the diffuse reflective type.

A speaker that outputs an alarm sound based on the alarm information output from the controller 40 may be provided on the analysis device 2. In this case, the speaker is one example of the notification device together with the display device 70.

The processing shown in FIG. 8 to FIG. 10 described as the processing procedure of the controller 40 may be executed by a personal computer 3.

The controller 40 may execute the processing of Step S102 to Step S109 shown in FIG. 8 when the operation of the start button is detected in Step S110 of FIG. 9. The controller 40 may execute the processing in Step S102 to Step S109 shown in FIG. 8 before controlling the gripper arm 14 to the open state in Step S112 of FIG. 9.

The housing 10 of the pretreatment apparatus 1 and the housing of the analysis device 2 may be configured by one housing.

### Aspects

It will be understood by those skilled in the art that the above-described embodiment and its modifications are illustrative of the following embodiments.

### (Item 1)

An analysis system according to one aspect of the present invention is an analysis system including a pretreatment apparatus for pretreating a sample.

The analysis system includes:
a gripper arm configured to convey a sample container; and
a controller configured to control the gripper arm,
wherein the gripper arm includes
a first gripper and a second gripper for holding the sample container by pinching the sample container,
a drive mechanism configured to change a size of a gripping space between the first gripper and the second gripper, and
a photoelectric sensor configured to emit light to the gripping space and detect the light from the gripping space, and
wherein the controller determines the presence or absence of the sample container in the gripping space based on the presence or absence of a detection signal of the photoelectric sensor.

According to the analysis system as recited in the above-described Item 1, whether a sample container is present between the grippers of the gripper arm can be detected by the optimum detection means considering the characteristics of the analysis system.

### (Item 2)

In the analysis system as recited in the above-described Item 1, the controller determines the presence or absence of the sample container in the gripping space in a conveyance process for the gripper arm to convey the sample container.

According to the analysis system as recited in the above-described Item 2, it is possible to detect that the sample container is detached from the gripper arm during the conveyance step.

### (Item 3)

In the analysis system as recited in the above-described Item 1 or 2,
the controller determines the presence or absence of the sample container in the gripping space when a power source of the pretreatment apparatus is turned on.

According to the analysis system as recited in the above-described Item 3, it is possible to specify whether the gripper arm is gripping the sample container when the power supply is turned on.

### (Item 4)

In the analysis system as recited in any one of the above-described Items 1 to 3, the pretreatment apparatus is provided with a first placement portion for placing the sample container, and the controller move the first gripper and the second gripper to the first placement portion before conveying the sample container to the first placement portion by the gripper arm, and determine the presence or absence of the sample container in the gripping space based on the presence or absence of the detection signal.

According to the analysis system as recited in the above-described Item 4, it is possible to determine whether the sample container is present at the first placement portion before moving the sample container to the first placement portion.

### (Item 5)

In the analysis system as recited in the above-described Item 4, the pretreatment apparatus is further provided with a second placement portion for placing the sample container, and the controller sequentially move the first gripper and the second gripper to each of the first placement portion and the second placement portion before conveying the sample container to the first placement portion by the gripper arm, and determines the presence or absence of the sample container in the gripping space at each of the first placement portion and the second placement portion.

According to the analysis system as recited in the above-described Item 5, it is possible to determine whether the sample container is present at the first placement portion or the second placement portion before moving the sample container to the first placement portion.

### (Item 6)

The analysis system as recited in the above-described Items 5, the controller is provided with a memory for storing position information on each of the first placement portion and the second placement portion, and the controller moves the first gripper and the second gripper to each of placement surfaces of the first placement portion and the second placement portion, based on the position information.

According to the analysis system as recited in the above-described Item 6, the first gripper and the second gripper can be moved to appropriate positions considering the size of each of the first placement portion and the second placement portion.

### (Item 7)

In the analysis system as recited in any one of the above-described Items 1 to 6, it further includes a notification device configured to notify a determination result of the presence or absence of the sample container by the controller.

According to the analysis system as recited in the above-described Item 7, the user can grasp the determination result of the presence or absence of the sample container and can take appropriate measures according to the circumstances at an early stage.

### (Item 8)

In the analysis system as recited in any one of the above-described Items 1 to 7,
the photoelectric sensor includes
a light-projecting unit for projecting the light to the gripping space; and
a light-receiving unit for receiving the light,
the gripper arm includes
a first arm including the first gripper, the first arm being configured to attach the light-projecting unit, and
a second arm including the second gripper, the second arm being configured to attach the light-receiving unit,
the first gripper and the second gripper each have a contact surface that comes into contact with the sample container, and
the light-projecting unit and the light-receiving unit are attached to positions that differ from the contact surface.

According to the analysis system as recited in Item 8, it is possible to prevent the light-projecting unit and the light-receiving unit from being compressed by the sample container and the contact surface and the function of the light-projecting unit and the light-receiving unit from being impaired.

### (Item 9)

In a method of controlling a gripper arm for conveying a sample container as recited in the above-described Items 9, the gripper arm includes a first gripper and a second gripper for holding the sample container by pinching the sample container.
the method comprises the steps of:
changing a size of a gripping space between the first gripper and the second gripper;
emitting light to the gripping space to detect the light from the gripping space; and
determining the presence or absence of the sample container in the gripping space, based on whether the light from the gripping space has been detected.

According to the method as recited in the above-described Item 9, it is possible to detect whether a sample container is present between the grippers of the gripper arm by the optimum detection means considering the characteristics of the analysis system.

While the embodiments of the present invention have been described, it should be understood that the embodiments disclosed herein are illustrative and not restrictive in all respects. The scope of the present invention is indicated by claims and is intended to include all modifications within the meaning and scope equivalent to the claims.

1. An analysis system including a pretreatment apparatus for pretreating a sample, comprising:
a gripper arm configured to convey a sample container; and
a controller configured to control the gripper arm,
wherein the gripper arm includes
a first gripper and a second gripper for gripping the sample container by pinching the sample container,
a drive mechanism configured to change a size of a gripping space between the first gripper and the second gripper, and
a photoelectric sensor configured to emit light to the gripping space and detect the light from the gripping space, and
wherein the controller determines the presence or absence of the sample container in the gripping space based on the presence or absence of a detection signal of the photoelectric sensor.

2. The analysis system as recited in claim 1,
wherein the controller determines the presence or absence of the sample container in the gripping space in a conveyance step for the gripper arm to convey the sample container.

3. The analysis system as recited in claim 1,
wherein the controller determines the presence or absence of the sample container in the gripping space when a power source of the pretreatment apparatus is turned on.

4. The analysis system as recited in claim 1,
wherein the pretreatment apparatus is provided with a first placement portion for placing the sample container, and
wherein the controller
move the first gripper and the second gripper to the first placement portion before conveying the sample container to the first placement portion by the gripper arm, and
determine the presence or absence of the sample container in the gripping space based on the presence or absence of the detection signal.

5. The analysis system as recited in claim 4,
wherein the pretreatment apparatus is further provided with a second placement portion for placing the sample container,
wherein the controller
sequentially moves the first gripper and the second gripper to each of the first placement portion and the second placement portion before conveying the sample container to the first placement portion by the gripper arm, and
determines the presence or absence of the sample container in the gripping space at each of the first placement portion and the second placement portion.

6. The analysis system as recited in claim 5,
wherein the controller is provided with a memory for storing position information on each of the first placement portion and the second placement portion, and
wherein the controller moves the first gripper and the second gripper to each of placement surfaces of the first placement portion and the second placement portion, based on the position information.

7. The analysis system as recited in claim 1, further comprising:
a notification device configured to notify a determination result of the presence or absence of the sample container by the controller.

8. The analysis system as recited in claim 1,
wherein the photoelectric sensor includes
a light-projecting unit for projecting the light to the gripping space; and
a light-receiving unit for receiving the light,
wherein the gripper arm includes
a first arm including the first gripper, the first arm being configured to attach the light-projecting unit, and
a second arm including the second gripper, the second arm being configured to attach the light-receiving unit,
wherein the first gripper and the second gripper each have a contact surface that comes into contact with the sample container, and
wherein the light-projecting unit and the light-receiving unit are attached to positions that differ from the contact surface.

9. A method of controlling a gripper arm for conveying a sample container, the gripper arm including a first gripper and a second gripper for holding the sample container by pinching the sample container,
the method comprising the steps of:
changing a size of a gripping space between the first gripper and the second gripper;
emitting light to the gripping space to detect the light from the gripping space; and
determining the presence or absence of the sample container in the gripping space, based on whether the light from the gripping space is detected.
